(19) United States
(12) Patent Application Publication
(10) Pub. No.: US 2019/0348692 A1
(43) Pub. Date: Nov. 14, 2019

(54) CELL FRAME, CELL STACK, AND REDOX FLOW BATTERY

(71) Applicant: Sumitomo Electric Industries, Ltd., Osaka-shi (JP)

(72) Inventors: Hayato FUJITA, Osaka-shi (JP); Haruhisa TOYODA, Osaka-shi (JP)

(73) Assignee: Sumitomo Electric Industries, Ltd., Osaka-shi (JP)

(21) Appl. No.: 16/482,622

(22) PCT Filed: Jul. 27, 2017
(86) PCT No.: PCT/JP2017/027328

§ 371 Date: Jul. 31, 2019

(51) Int. Cl. H01M 8/0273; H01M 8/18

(52) U.S. Cl. CPC H01M 8/0273; H01M 8/188

(57) ABSTRACT

A cell frame includes a bipolar plate and a frame body. The cell frame has an introduction-side flow guiding channel connecting to an inlet slit and extending in a width direction of the cell frame, a drainage-side flow guiding channel connecting to an outlet slit and extending in the width direction, and a diffusion channel unit configured to allow the introduction-side flow guiding channel to communicate with the drainage-side flow guiding channel. The diffusion channel unit includes an introduction-side vertical channel branching off the introduction-side flow guiding channel and extending toward, but not directly communicating with, the drainage-side flow guiding channel; a drainage-side vertical channel branching off the drainage-side flow guiding channel and extending toward, but not directly communicating with, the introduction-side flow guiding channel; and one or more horizontal channels communicating with both the introduction-side vertical channel and the drainage-side vertical channel.

### TECHNICAL FIELD

The present invention relates to a cell frame, a cell stack, and a redox flow battery.

### BACKGROUND ART

Patent Literatures (PTLs) 1 to 4 describe a cell stack formed by stacking a plurality of sets of a cell frame, a positive electrode, a membrane, a negative electrode, and the cell frame and sandwiching the resulting layered body between supply/drainage plates; and a redox flow battery using the cell stack. The cell frame includes a bipolar plate sandwiched between the positive electrode and the negative electrode, and a frame body configured to support the bipolar plate from the outer edge of the bipolar plate. In this configuration, one cell is formed between bipolar plates of adjacent cell frames.

PTLs 1 to 4 disclose a configuration in which, to fully distribute the electrolyte over the positive electrode and the negative electrode in the cell, a plurality of channels are formed in one surface of the bipolar plate facing the positive electrode and in the other surface of the bipolar plate facing the negative electrode.

### CITATION LIST

### Patent Literature

PTL 1: Japanese Unexamined Patent Application Publication No. 2015-122230

PTL 2: Japanese Unexamined Patent Application Publication No. 2015-122231

PTL 3: Japanese Unexamined Patent Application Publication No. 2015-138771

PTL 4: Japanese Unexamined Patent Application Publication No. 2015-210849

### SUMMARY OF INVENTION

An object of the present disclosure is to provide a cell frame and a cell stack that can improve battery performance of a redox flow battery. Another object of the present disclosure is to provide a redox flow battery that has high battery performance.

### Solution to Problem

A cell frame according to the present disclosure includes a bipolar plate interposed between a positive electrode and a negative electrode of a redox flow battery, and a frame body configured to support the bipolar plate from an outer edge of the bipolar plate. The frame body has an inlet slit for introducing an electrolyte into the bipolar plate and an outlet slit for draining the electrolyte out of the bipolar plate. The cell frame has an introduction-side flow guiding channel connecting to the inlet slit and extending in a width direction of the cell frame, a drainage-side flow guiding channel connecting to the outlet slit and extending in the width direction, and a diffusion channel unit configured to allow the introduction-side flow guiding channel to communicate with the drainage-side flow guiding channel. The diffusion channel unit includes an introduction-side vertical channel branching off the introduction-side flow guiding channel and extending toward, but not directly communicating with, the drainage-side flow guiding channel; a drainage-side vertical channel branching off the drainage-side flow guiding channel and extending toward, but not directly communicating with, the introduction-side flow guiding channel; and one or more horizontal channels communicating with both the introduction-side vertical channel and the drainage-side vertical channel.

A cell stack according to the present disclosure includes the cell frame according to the present disclosure.

A redox flow battery according to the present disclosure includes the cell stack according to the present disclosure.

### BRIEF DESCRIPTION OF DRAWINGS

FIG. 1 is an explanatory diagram illustrating an operating principle of a redox flow battery according to an embodiment.

FIG. 2 is a schematic diagram of the redox flow battery according to the embodiment.

FIG. 3 is a schematic diagram of a cell stack according to an embodiment.

FIG. 4 is a plan view of a cell frame according to a first embodiment as seen from one side.

FIG. 5 is a plan view of a cell frame according to a second embodiment as seen from one side.

### DESCRIPTION OF EMBODIMENTS

### Problems to be Solved by Invention

In recent years, there has been demand for development of environmentally friendly energy systems. As part of such systems, redox flow batteries with improved battery performance have been expected to be developed. With a focus placed on channels in a bipolar plate included in a cell frame of a redox flow battery, the present inventors have studied configurations that can improve the battery performance of the redox flow battery.

### Description of Embodiments of Invention of Present Application

First, embodiments of the invention of the present application will be summarized.

<1> A cell frame according to an embodiment includes a bipolar plate interposed between a positive electrode and a negative electrode of a redox flow battery, and a frame body configured to support the bipolar plate from an outer edge of the bipolar plate. The frame body has an inlet slit for introducing an electrolyte into the bipolar plate and an outlet slit for draining the electrolyte out of the bipolar plate. The cell frame has an introduction-side flow guiding channel connecting to the inlet slit and extending in a width direction of the cell frame, a drainage-side flow guiding channel connecting to the outlet slit and extending in the width direction, and a diffusion channel unit configured to allow the introduction-side flow guiding channel to communicate with the drainage-side flow guiding channel. The diffusion channel unit includes an introduction-side vertical channel branching off the introduction-side flow guiding channel and extending toward, but not directly communicating with, the drainage-side flow guiding channel; a drainage-side vertical channel branching off the drainage-side flow guiding channel and extending toward, but not directly communicating with, the introduction-side flow guiding channel; and one or more horizontal channels communicating with both the introduction-side vertical channel and the drainage-side vertical channel.

With the diffusion channel unit in the cell frame, the electrolyte can be rapidly distributed over the entire surface of the bipolar plate of the cell frame and uniformly supplied over the entire surface of the electrode overlaid on the bipolar plate. Also, with the diffusion channel unit in the cell frame, the electrolyte supplied to the electrode and changed in the valence of active material can be rapidly and uniformly collected from the entire surface of the electrode.

The diffusion channel unit in the cell frame allows the introduction-side flow guiding channel to communicate with the drainage-side flow guiding channel. By thus allowing the introduction-side flow guiding channel to communicate with the drainage-side flow guiding channel, gas produced by battery reaction of the electrolyte, gas originally entrained in the electrolyte, or gas mixed into the electrolyte from a gas phase in an electrolyte tank as the electrolyte circulates, can be readily released from inside the cell of the redox flow battery. This can reduce problems associated with retention of gas in the cell, such as reduction of the contact area between the electrolyte and the electrode caused by gas retained in the cell, and can also reduce increase in the cell resistance of the redox flow battery caused by such a problem.

<2> In an aspect of the cell frame according to the embodiment, the plurality of horizontal channels may include a first horizontal channel extending from an end portion of the introduction-side vertical channel toward the drainage-side vertical channel, and a second horizontal channel extending from an end portion of the drainage-side vertical channel toward the introduction-side vertical channel.

Adding the first horizontal channel can reduce the amount of electrolyte flowing straight through the end portion of the introduction-side vertical channel toward the drainage-side flow guiding channel and can increase the amount of electrolyte flowing from the end portion of the introduction-side vertical channel along the width direction of the cell frame (i.e., along the first horizontal channel). Also, adding the second horizontal channel facilitates formation of the flow of electrolyte from the introduction-side flow guiding channel toward the second horizontal channel, in addition to the flow of electrolyte from the introduction-side flow guiding channel toward the introduction-side vertical channel. With the first horizontal channel and the second horizontal channel, it is possible to facilitate distribution of the electrolyte over the area which is not easily accessible due to the absence of channels. The electrolyte can thus be readily distributed over the entire surface the bipolar plate or, in other words, over the entire surface of the electrode overlaid on the bipolar plate.

<3> In another aspect of the cell frame according to the embodiment, a width of the horizontal channel may be smaller than a width of the introduction-side vertical channel and a width of the drainage-side vertical channel.

Making the horizontal channel narrower than the vertical channels facilitates overflow of the electrolyte out of the horizontal channel. The electrolyte overflowed out of the horizontal channel can spread out in the planar direction of the bipolar plate. The electrolyte is thus readily distributed over the entire surface of the bipolar plate or, in other words, over the entire surface of the electrode overlaid on the bipolar plate.

<4> In an aspect of the cell frame according to the embodiment where the horizontal channel is narrower than the vertical channels, the width of the horizontal channel may be greater than or equal to 1/10 of, but smaller than, the width of the introduction-side vertical channel and the width of the drainage-side vertical channel.

Making the width of the horizontal channel greater than or equal to 1/10 of those of the vertical channels can promote diffusion of the electrolyte in the planar direction of the bipolar plate. Making the width of the horizontal channel smaller than those of the vertical channels can prevent an excessive amount of liquid from passing through the horizontal channel and can reduce the amount of electrolyte drained into the outlet slit without contributing to the battery reaction. Thus, by setting the ratio between the width of the horizontal channel and the widths of the vertical channels within the range described above, the entire surface of the electrode overlaid on the bipolar plate can be efficiently used.

<5> In another aspect of the cell frame according to the embodiment, a depth of the horizontal channel may be smaller than a depth of the introduction-side vertical channel and the drainage-side vertical channel.

Making the horizontal channel shallower than the vertical channels facilitates overflow of the electrolyte out of the horizontal channel. The electrolyte overflowed out of the horizontal channel can spread out in the planar direction of the bipolar plate. The electrolyte can thus be readily distributed over the entire surface of the bipolar plate or, in other words, over the entire surface of the electrode overlaid on the bipolar plate.

<6> In another aspect of the cell frame according to the embodiment, a plurality of diffusion channel units may be arranged in the width direction of the cell frame, and adjacent ones of the diffusion channel units may share the introduction-side vertical channel or the drainage-side vertical channel.

In this configuration, the vertical and horizontal channels of the plurality of diffusion channel units arranged in the width direction of the cell frame form a grid pattern. This further facilitates distribution of the electrolyte over the entire surface of the bipolar plate.

<7> In another aspect of the cell frame according to the embodiment, the introduction-side flow guiding channel, the drainage-side flow guiding channel, and the diffusion channel unit may be provided in the bipolar plate.

With the configuration in which the bipolar plate has all the channels, the configuration of the frame body is simplified and this facilitates manufacture of the cell frame.

<8> In another aspect of the cell frame according to the embodiment, the introduction-side flow guiding channel and the drainage-side flow guiding channel may be provided in the frame body, and the diffusion channel unit may be provided in the bipolar plate.

With the configuration in which the frame body has the flow guiding channels, the electrolyte can be diffused in the width direction of the cell frame before being introduced into the bipolar plate.

<9> A cell stack according to an embodiment includes the cell frame according to the embodiment.

When a redox flow battery is constructed using the cell stack described above, the battery performance of the redox flow battery can be improved. This is because, with the bipolar plate of the embodiment included in the cell frame of the cell stack, the electrolyte can be readily distributed over the entire surface of the electrode and gas is less likely to be retained in the electrode.

<10> A redox flow battery according to an embodiment includes the cell stack according to the embodiment.

The redox flow battery according to the embodiment provides high battery performance because it uses the cell stack according to the embodiment.

### Details of Embodiments of Invention of Present Application

Hereinafter, embodiments of a redox flow battery (RF battery) according to the present disclosure will be described. The invention of the present application is not limited to configurations described in the embodiments, but is defined by the appended claims. The invention of the present application is intended to encompass all changes within meanings and scopes equivalent to the claims.

### First Embodiment

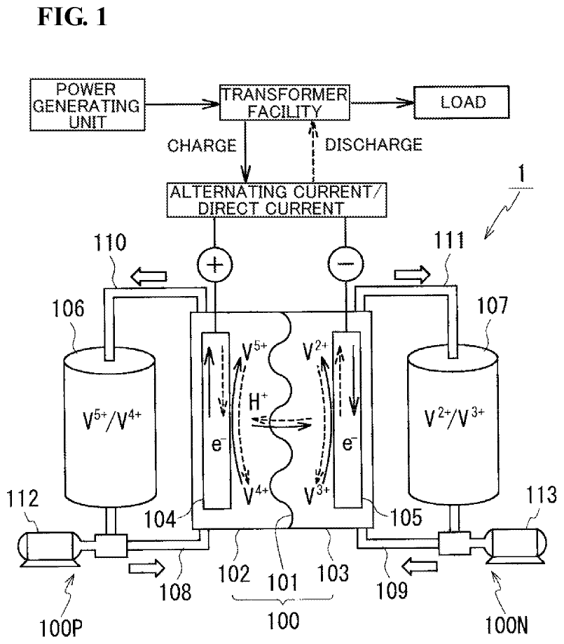

A redox flow battery (hereinafter referred to as RF battery) according to an embodiment will be described on the basis of FIGS. 1 to 4.

<<RF Battery>>

An RF battery is a storage battery of an electrolyte circulation type, and is used to store electricity generated, for example, by solar photovoltaic power generation or wind power generation based on new energy. An operating principle of an RF battery 1 is illustrated in FIG. 1. The RF battery 1 is a battery that performs charge and discharge using a difference between the oxidation-reduction potential of active material ions contained in a positive electrolyte and the oxidation-reduction potential of active material ions contained in a negative electrolyte. The RF battery 1 includes a cell 100 that is divided into a positive cell 102 and a negative cell 103 by a membrane 101 that allows hydrogen ions to pass therethrough.

The positive cell 102 includes a positive electrode 104, and connects through pipes 108 and 110 to a positive electrolyte tank 106 that stores the positive electrolyte. The pipe 108 is provided with a pump 112. These components 106, 108, 110, and 112 form a positive electrolyte circulation mechanism 100P that circulates the positive electrolyte. Similarly, the negative cell 103 includes a negative electrode 105, and connects through pipes 109 and 111 to a negative electrolyte tank 107 that stores the negative electrolyte. The pipe 109 is provided with a pump 113. These components 107, 109, 111, and 113 form a negative electrolyte circulation mechanism 100N that circulates the negative electrolyte. The electrolytes stored in the respective tanks 106 and 107 are circulated in the cells 102 and 103 by the pumps 112 and 113 during charge and discharge. When neither charge nor discharge is being performed, the pumps 112 and 113 are at rest and the electrolytes are not circulated.

<<Cell Stack>>

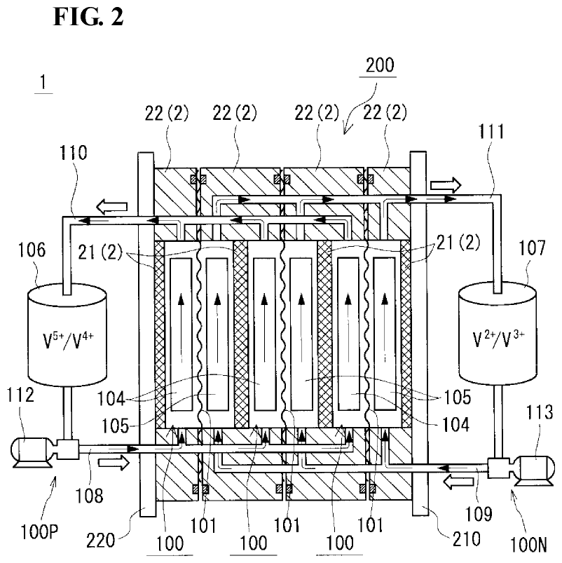

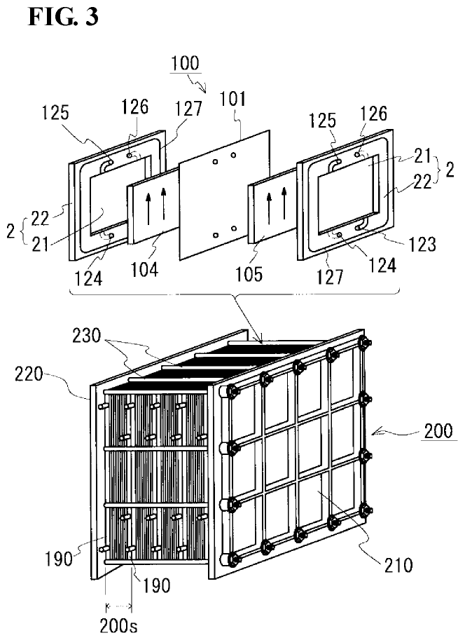

The cell 100 is typically formed inside a structure called a cell stack 200, such as that illustrated in FIGS. 2 and 3. The cell stack 200 is formed by fastening, with a fastening mechanism 230, a layered structure called a sub-stack 200s (see FIG. 3) sandwiched between two end plates 210 and 220 on both sides (note that a plurality of sub-stacks 200s are used in the configuration illustrated in FIG. 3).

The sub-stacks 200s (see FIG. 3) are each formed by stacking a plurality of sets of a cell frame 2, the positive electrode 104, the membrane 101, and the negative electrode 105 and sandwiching the resulting layered body between two supply/drainage plates 190 (see the lower part of FIG. 3, not shown in FIG. 2). An exemplary feature of the RF battery 1 of the present embodiment, configured as described above, is the configuration of the cell frame 2. Hereinafter, the configuration of the cell frame 2 will be described in detail.

<<Cell Frame>>

The cell frame 2 includes a frame body 22 having a through window and a bipolar plate 21 configured to close the through window. That is, the frame body 22 supports the bipolar plate 21 from the outer edge of the bipolar plate 21. The cell frame 2 is made, for example, by forming the frame body 22 integrally with the outer edge of the bipolar plate 21. Alternatively, the cell frame 2 may be made by preparing the frame body 22 having a through hole with a thin portion therearound and the bipolar plate 21 made separately from the frame body 22, and then fitting the outer edge of the bipolar plate 21 into the thin portion of the frame body 22. The positive electrode 104 is disposed in contact with one surface of the bipolar plate 21 of the cell frame 2, and the negative electrode 105 is disposed in contact with the other surface of the bipolar plate 21. In this configuration, one cell 100 is formed between bipolar plates 21 fitted in respective cell frames 2 adjacent to each other.

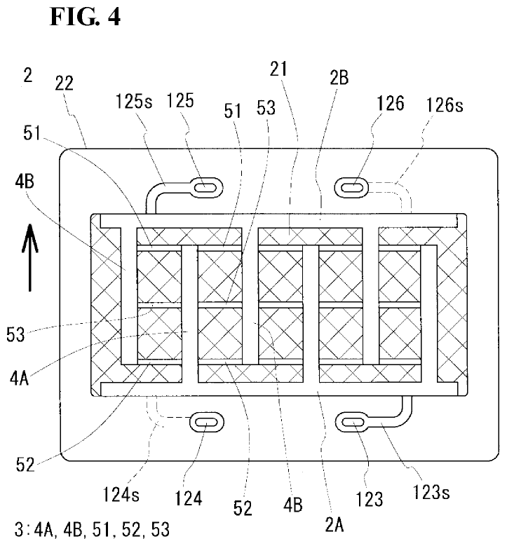

Liquid supply manifolds 123 and 124 and liquid drainage manifolds 125 and 126 (see FIGS. 3 and 4) formed in the cell frame 2 allow the electrolyte to flow through the supply/drainage plates 190 (see FIG. 3) into the cell 100. The positive electrolyte is supplied from the liquid supply manifold 123 to the positive electrode 104 through an inlet slit 123s (see FIG. 4) formed on one side of the cell frame 2 (i.e., front side of the drawing), and then drained into the liquid drainage manifold 125 through an outlet slit 125s (see FIG. 4) formed in the upper part of the cell frame 2. Similarly, the negative electrolyte is supplied from the liquid supply manifold 124 to the negative electrode 105 through an inlet slit 124s (see FIG. 4) formed on the other side of the cell frame 2 (i.e., back side of the drawing), and then drained into the liquid drainage manifold 126 through an outlet slit 126s (see FIG. 4) formed in the upper part of the cell frame 2. A ring-shaped sealing member 127, such as an O-ring or flat gasket, is disposed between cell frames 2. This reduces leakage of the electrolyte from the sub-stack 200s.

The bipolar plate 21 of the present embodiment has a plurality of channels (not shown in FIG. 3) formed in the front surface thereof. The configuration of the channels will now be described using a plan view (FIG. 4) of the cell frame 2. The surface illustrated in FIG. 4 is adjacent to the positive electrode 104 (see FIG. 3), and the bipolar plate 21 is cross-hatched, except for channels 2A, 2B, 4A, 4B, 51, 52, and 53. A general direction in which the electrolyte flows in the cell frame 2 (flow direction) is upward in the drawing, as indicated by a bold arrow on the left side.

With the channels 2A, 2B, 4A, 4B, 51, 52, and 53 formed in the front surface of the bipolar plate 21 as illustrated in the plan view (FIG. 4), the positive electrolyte supplied through the inlet slit 123s to the front surface of the bipolar plate 21 (on the front side in the drawing) is uniformly distributed over the entire surface of the positive electrode 104 (see FIG. 3). Also, with the channels 2A, 2B, 4A, 4B, 51, 52, and 53, the positive electrolyte containing a positive-electrode active material with a valence changed in the positive electrode 104 (see FIG. 3) is rapidly collected from the entire surface of the positive electrode 104 and guided to the outlet slit 125s. The details of the channels 2A, 2B, 4A, 4B, 51, 52, and 53 will be described later on.

The back surface of the bipolar plate 21 has channels similar to those illustrated in FIG. 4. With these channels, the negative electrolyte is also uniformly distributed over the negative electrode 105 (see FIG. 3) disposed on the back surface of the bipolar plate 21, and the negative electrolyte containing a negative-electrode active material with a valence changed in the negative electrode 105 is rapidly collected from the entire surface of the negative electrode 105. The configuration of the channels in the back surface of the bipolar plate 21 will not be described, as it is the same as that of the channels 2A, 2B, 4A, 4B, 51, 52, and 53 illustrated in FIG. 4. The following explanation will mainly refer to the configuration on the positive side.

[Flow Guiding Channel]

An introduction-side flow guiding channel 2A on the lower side of the bipolar plate 21 in the vertical direction extends in the width direction of the cell frame 2, which is a direction intersecting (or in the present embodiment, orthogonal to) the flow direction, and connects to an end portion of the inlet slit 123s. The introduction-side flow guiding channel 2A is a channel for rapid diffusion of the positive electrolyte introduced therein through the inlet slit 123s, in the width direction of the cell frame 2 (i.e., in the direction orthogonal to the flow direction). Diffusing the positive electrolyte in the width direction of the cell frame 2 facilitates distribution of the positive electrolyte over the entire surface of the bipolar plate 21 or, in other words, over the entire surface of the positive electrode 104 (see FIG. 3) overlaid on the bipolar plate 21.

A drainage-side flow guiding channel 2B on the upper side of the bipolar plate 21 in the vertical direction also extends in the width direction of the cell frame 2, which is the direction intersecting (or in the present embodiment, orthogonal to) the flow direction, and connects to an end portion of the outlet slit 125s. The drainage-side flow guiding channel 2B is a channel for facilitating collection of the positive electrolyte from across the length in the width direction of the cell frame 2.

[Diffusion Channel Unit]

In addition to the flow guiding channels 2A and 2B described above, the bipolar plate 21 of the cell frame 2 according to the present embodiment includes a plurality of diffusion channel units 3 arranged in the width direction of the cell frame 2. The diffusion channel units 3 each include an introduction-side vertical channel 4A, a drainage-side vertical channel 4B, and at least one horizontal channel (or in the present embodiment, a plurality of horizontal channels 51, 52, and 53) communicating with both the vertical channels 4A and 4B. The diffusion channel units 3 have the function of allowing the introduction-side flow guiding channel 2A to communicate with the drainage-side flow guiding channel 2B, and thereby diffusing the positive electrolyte in the planar direction of the bipolar plate 21.

In the present embodiment, two adjacent ones of the diffusion channel units 3, 3 share some of their components. Specifically, the introduction-side vertical channel 4A of the diffusion channel unit 3 at the left end of the drawing (i.e., the second left channel extending in the vertical direction) also serves as the introduction-side vertical channel 4A of the second diffusion channel unit 3 from the left of the drawing. Similarly, the drainage-side vertical channel 4B of the second diffusion channel unit 3 from the left of the drawing (i.e., the third left channel extending in the vertical direction) also serves as the drainage-side vertical channel 4B of the third diffusion channel unit 3 from the left of the drawing. In this configuration, where a plurality of diffusion channel units 3 share some components, two adjacent ones of the diffusion channel units 3, 3 communicate with each other through the horizontal channels 51, 52, and 53 to allow the channels 4A, 4B, 51, 52, and 53 in the bipolar plate 21 to be arranged in a grid pattern. Unlike the present embodiment, two adjacent ones of the diffusion channel units 3, 3 may be independent of each other and one diffusion channel unit 3 does not necessarily need to communicate with the other diffusion channel unit 3.

[[Vertical Channel]]

The introduction-side vertical channel 4A of each diffusion channel unit 3 communicates with the introduction-side flow guiding channel 2A and extends toward the drainage-side flow guiding channel 2B. Although the introduction-side vertical channel 4A extends along the flow direction of the positive electrolyte in the present embodiment, it may extend at an angle from the flow direction. Although the introduction-side vertical channel 4A of the present embodiment is a linear channel, it may be a zigzag or meandering channel. The introduction-side vertical channel 4A extends toward, but does not directly communicate with, the drainage-side flow guiding channel 2B.

On the other hand, the drainage-side vertical channel 4B communicates with the drainage-side flow guiding channel 2B and extends toward the introduction-side flow guiding channel 2A. Although the drainage-side vertical channel 4B extends along the flow direction of the positive electrolyte in the present embodiment, it may extend at an angle from the flow direction. Although the drainage-side vertical channel 4B of the present embodiment is a linear channel, it may be a zigzag or meandering channel. The drainage-side vertical channel 4B extends toward, but does not directly communicate with, the introduction-side flow guiding channel 2A.

The width of the vertical channels 4A and 4B may be selected appropriately in accordance with the size of the cell frame 2. For example, if the RF battery 1 (see FIG. 2) is a standard 1-kW class RF battery, the vertical channels 4A and 4B may be 0.5 mm or more and 7.0 mm or less in width. The vertical channels 4A and 4B may be 1.0 mm or more and 2.0 mm or less in width.

The depth of the vertical channels 4A and 4B may also be selected appropriately in accordance with the size of the cell frame 2. For example, if the RF battery 1 (see FIG. 2) is a standard 1-kW class RF battery, the vertical channels 4A and 4B may be 0.5 mm or more and 7.0 mm or less in depth. The vertical channels 4A and 4B may be 1.5 mm or more and 2.0 mm or less in depth. Note that the depth of the vertical channels 4A and 4B in the present specification refers to the length from the front surface of the bipolar plate 21 to the deepest point of the vertical channels 4A and 4B.

The distance from the end portion of the introduction-side vertical channel 4A (or drainage-side vertical channel 4B) to the drainage-side flow guiding channel 2B (or introduction-side flow guiding channel 2A), that is, the length of a gap between channels, may be selected appropriately in accordance with the size of the cell frame 2. For example, if the RF battery 1 (see FIG. 2) is a standard 1-kW class RF battery, the distance described above may be 3 mm or more and 30 mm or less. The distance described above may be 3 mm or more and 25 mm or less.

The cross-sectional shape of the vertical channels 4A and 4B in the extension direction is not particularly limited. For example, the cross-section may be rectangular, V-shaped, or semicircular. Although the vertical channels 4A and 4B are equal in width, depth, and cross-sectional shape in the present embodiment, they may have different widths, depths, or cross-sectional shapes.

[[Horizontal Channel]]

The diffusion channel units 3 each further include the first horizontal channel 51, the second horizontal channel 52, and the intermediate horizontal channel 53 that extend in a direction intersecting the introduction-side vertical channel 4A and the drainage-side vertical channel 4B. Although three horizontal channels 51, 52, and 53 are formed in the present embodiment, the number of horizontal channels may be two or more than three. At least one of the plurality of horizontal channels 51, 52, and 53 needs to communicate with both the vertical channels 4A and 4B. In the present embodiment, all the horizontal channels 51, 52, and 53 communicate with both the vertical channels 4A and 4B.

The first horizontal channel 51 extends from the end portion of the introduction-side vertical channel 4A toward the drainage-side vertical channel 4B. Although the first horizontal channel 51 extends in an orthogonal direction orthogonal to the flow direction of the positive electrolyte in the present embodiment, it may extend in a direction intersecting the orthogonal direction. Although the first horizontal channel 51 of the present embodiment is a linear channel, it may be a zigzag or meandering channel.

Adding the first horizontal channel 51 can reduce the amount of positive electrolyte flowing straight through the end portion of the introduction-side vertical channel 4A toward the drainage-side flow guiding channel 2B, and can increase the amount of positive electrolyte flowing from the end portion of the introduction-side vertical channel 4A in the width direction of the cell frame 2. This facilitates distribution of the positive electrolyte over the area on the upper side of the first horizontal channel 51 in the bipolar plate 21.

The second horizontal channel 52 extends from the end portion of the drainage-side vertical channel 4B toward the introduction-side vertical channel 4A. Although the second horizontal channel 52 extends in the orthogonal direction described above, it may extend in a direction intersecting the orthogonal direction. Although the second horizontal channel 52 of the present embodiment is a linear channel, it may be a zigzag or meandering channel.

Adding the second horizontal channel 52 facilitates formation of the flow of positive electrolyte from the introduction-side flow guiding channel 2A toward the second horizontal channel 52 along the flow direction, in addition to the flow of positive electrolyte from the introduction-side flow guiding channel 2A toward the introduction-side vertical channel 4A. This can facilitate distribution of the positive electrolyte over the area between the introduction-side flow guiding channel 2A and the second horizontal channel 52 in the bipolar plate 21.

The intermediate horizontal channel 53 is formed between the first horizontal channel 51 and the second horizontal channel 52. The intermediate horizontal channel 53 of the present embodiment is formed parallel to the horizontal channels 51 and 52. The number of intermediate horizontal channels 53 may be appropriately selected. Although there is one intermediate horizontal channel 53 in the present embodiment, there may be more than one intermediate horizontal channel 53.

The intermediate horizontal channel 53 allows formation of the flow of positive electrolyte from the first horizontal channel 51 toward the intermediate horizontal channel 53 along the flow direction and the flow of positive electrolyte from the intermediate horizontal channel 53 toward the second horizontal channel 52 along the flow direction.

The horizontal channels 51, 52, and 53 are preferably narrower than the vertical channels 4A and 4B. With the horizontal channels 51, 52, and 53 narrower than the vertical channels 4A and 4B, it is possible to reduce the occurrence of a leak path of positive electrolyte which extends straight from the inlet slit 123s to the outlet slit 125s with little contact with the positive electrode 104 (see FIG. 3). Specifically, the width of the horizontal channels 51, 52, and 53 is preferably greater than or equal to 1/10 of, but smaller than, the width of the vertical channels 4A and 4B.

The horizontal channels 51, 52, and 53 may be as deep as the vertical channels 4A and 4B, or may be either deeper or shallower than the vertical channels 4A and 4B. The horizontal channels 51, 52, and 53 of the present embodiment are shallower than the vertical channels 4A and 4B. With the horizontal channels 51, 52, and 53 shallower than the vertical channels 4A and 4B, it is possible to reduce the occurrence of a leak path of positive electrolyte and distribute the positive electrolyte over the entire surface of the bipolar plate 21. Specifically, the depth of the horizontal channels 51, 52, and 53 is preferably greater than or equal to 1/10 of, but smaller than, the depth of the vertical channels 4A and 4B. Note that the depth of the horizontal channels 51, 52, and 53 in the present specification refers to the length from the front surface of the bipolar plate 21 to the deepest point of the horizontal channels 51, 52, and 53.

As in the case of the vertical channels 4A and 4B, the cross-sectional shape of the horizontal channels 51, 52, and 53 is not particularly limited. For example, the cross-section may be rectangular, V-shaped, or semicircular. Although the horizontal channels 51, 52, and 53 are equal in width, depth, and cross-sectional shape in the present embodiment, they may have different widths, depths, or cross-sectional shapes.

[[Others]]

An auxiliary channel may be added to the diffusion channel unit 3. The auxiliary channel is disposed between the introduction-side vertical channel 4A and the drainage-side vertical channel 4B and extends in a direction intersecting the vertical channels 4A and 4B, but does not allow the vertical channels 4A and 4B to communicate with each other. The auxiliary channel may be a channel that communicates with the introduction-side vertical channel 4A but does not communicate with the drainage-side vertical channel 4B, or a channel that does not communicate with the introduction-side vertical channel 4A but communicates with the drainage-side vertical channel 4B, or may be a channel that communicates with neither of the vertical channels 4A and 4B. The number of auxiliary channels may be one or more. With the auxiliary channel, it is possible to reduce the occurrence of a leak path of positive electrolyte and facilitate distribution of the positive electrolyte over the entire surface of the bipolar plate 21.

<<Advantageous Effects>>

By using the cell frame 2 with the flow guiding channels 2A and 2B and the diffusion channel units 3 described with reference to FIG. 4, the battery performance of the RF battery 1 is improved. This is particularly because by adding a plurality of diffusion channel units 3 to the bipolar plate 21, a grid of channels is created in the bipolar plate 21 and this facilitates distribution of the positive electrolyte over the entire surface of the bipolar plate 21.

Also, by using the cell frame 2 illustrated in FIG. 4, gas produced by battery reaction of the electrolyte, or gas originally entrained in the electrolyte, can be readily released from the cell 100 (see FIGS. 1 and 2). This is because the diffusion channel units 3 allow the introduction-side flow guiding channel 2A to communicate with the drainage-side flow guiding channel 2B. Since this makes it difficult for gas to be retained in the cell 100, it is possible to reduce problems, such as reduction of the contact area between the electrolyte and the electrode, caused by retained gas.

<<Other Configurations>>

By increasing the weight per unit area of the electrodes 104 and 105 (see FIG. 3), the contact area between the electrodes 104 and 105 and the electrolyte is increased and the battery performance of the RF battery 1 (see FIGS. 1 and 2) is improved. At the same time, however, the space between the electrodes 104 and 105 is narrowed and the structure becomes complex, and this leads to retention of gas in the cell 100. On the other hand, in the RF battery 1 of the present embodiment, which employs the bipolar plate 21 illustrated in FIG. 4, gas is readily released from the cell 100 and the weight per unit area of the electrodes 104 and 105 can be increased. Specifically, for example, the weight per unit area of the electrodes 104 and 105 may be 30 g/m² or more, or may even be 50 g/m² or more. The upper limit of the weight per unit area is 500 g/m².

### Second Embodiment

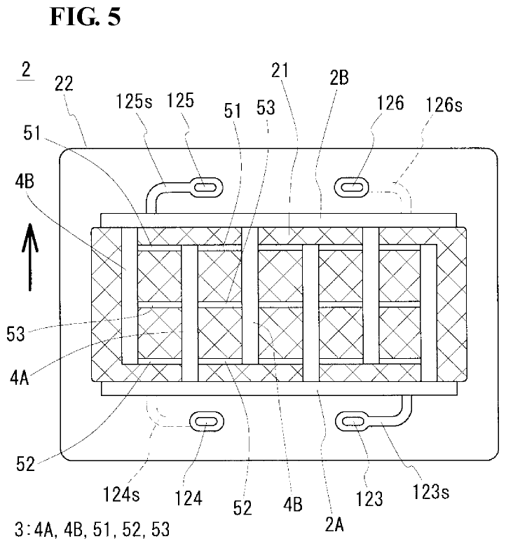

In a second embodiment, the cell frame 2 will be described, on the basis of FIG. 5, in which the frame body 22 has the flow guiding channels 2A and 2B and the bipolar plate 21 has the diffusion channel units 3.

As illustrated in FIG. 5, in the cell frame 2 of the present embodiment, the inner edge of the frame body 22 (or portion near the through window into which the bipolar plate 21 is fitted) has the introduction-side flow guiding channel 2A in a frame piece thereof adjacent to the liquid supply manifolds 123 and 124, and has the drainage-side flow guiding channel 2B in another frame piece thereof adjacent to the liquid drainage manifolds 125 and 126. The introduction-side flow guiding channel 2A extends along a direction in which the liquid supply manifolds 123 and 124 are arranged side by side and connects to the through window on the upper side thereof (adjacent to the liquid drainage manifolds 125 and 126). The drainage-side flow guiding channel 2B extends along a direction in which the liquid drainage manifolds 125 and 126 are arranged side by side and connects to the through window on the lower side thereof (adjacent to the liquid supply manifolds 123 and 124).

The bipolar plate 21 has a plurality of diffusion channel units 3 arranged in the width direction of the cell frame 2. The introduction-side vertical channel 4A of each diffusion channel unit 3 directly connects to the introduction-side flow guiding channel 2A, but does not directly connect to the drainage-side flow guiding channel 2B. The drainage-side vertical channel 4B of each diffusion channel unit 3 directly connects to the drainage-side flow guiding channel 2B, but does not directly connect to the introduction-side flow guiding channel 2A. As in the configuration of the first embodiment, each diffusion channel unit 3 includes the horizontal channels 51, 52, and 53 communicating with both the vertical channels 4A and 4B.

<<Advantageous Effects>>

The configuration of the present embodiment also allows distribution of the electrolyte over the entire surface of the bipolar plate 21, makes it difficult for gas in the electrolyte to be retained in the cell 100 (see FIGS. 1 and 2), and thus can improve the battery performance of the RF battery 1.

### <Application>

The cell frame of any of the embodiments can be suitably used to build a storage battery of a fluid flow type, such as an RF battery. For power generation based on new energy, such as solar photovoltaic power generation or wind power generation, the RF battery including the cell stack of any of the embodiments can be used as a storage battery that aims, for example, to stabilize the output of power generation, store electricity when there is a surplus of generated power, and provide load leveling. The RF battery may be installed in a general power plant and used as a large-capacity storage battery that aims to provide a measure against momentary voltage drops or power failure and to provide load leveling.

### REFERENCE SIGNS LIST

1: RF battery (redox flow battery)

2: cell frame
21: bipolar plate, 22: frame body
123, 124: liquid supply manifold, 125, 126: liquid drainage manifold
123s, 124s: inlet slit, 125s, 126s: outlet slit
127: ring-shaped sealing member
2A: introduction-side flow guiding channel, 2B: drainage-side flow guiding channel

3: diffusion channel unit
4A: introduction-side vertical channel, 4B: drainage-side vertical channel
51: first horizontal channel (horizontal channel), 52: second horizontal channel (horizontal channel), 53: intermediate horizontal channel (horizontal channel)

100: cell, 101: membrane, 102: positive cell, 103: negative cell
100P: positive electrolyte circulation mechanism, 100N: negative electrolyte circulation mechanism
104: positive electrode, 105: negative electrode, 106: positive electrolyte tank
107: negative electrolyte tank, 108, 109, 110, 111: pipe
112, 113: pump

200: cell stack
190: supply/drainage plate, 200s: sub-stack
210, 220: end plate
230: fastening mechanism

1. A cell frame comprising a bipolar plate interposed between a positive electrode and a negative electrode of a redox flow battery, and a frame body configured to support the bipolar plate from an outer edge of the bipolar plate, the frame body having an inlet slit for introducing an electrolyte into the bipolar plate and an outlet slit for draining the electrolyte out of the bipolar plate,
wherein the cell frame has
an introduction-side flow guiding channel connecting to the inlet slit and extending in a width direction of the cell frame,
a drainage-side flow guiding channel connecting to the outlet slit and extending in the width direction, and
a diffusion channel unit configured to allow the introduction-side flow guiding channel to communicate with the drainage-side flow guiding channel; and
the diffusion channel unit includes
an introduction-side vertical channel branching off the introduction-side flow guiding channel and extending toward, but not directly communicating with, the drainage-side flow guiding channel,
a drainage-side vertical channel branching off the drainage-side flow guiding channel and extending toward, but not directly communicating with, the introduction-side flow guiding channel, and
one or a plurality of horizontal channels communicating with both the introduction-side vertical channel and the drainage-side vertical channel.

2. The cell frame according to claim 1, wherein the plurality of horizontal channels include
a first horizontal channel extending from an end portion of the introduction-side vertical channel toward the drainage-side vertical channel, and
a second horizontal channel extending from an end portion of the drainage-side vertical channel toward the introduction-side vertical channel.

3. The cell frame according to claim 1, wherein a width of the horizontal channel is smaller than a width of the introduction-side vertical channel and a width of the drainage-side vertical channel.

4. The cell frame according to claim 3, wherein the width of the horizontal channel is greater than or equal to 1/10 of, but smaller than, the width of the introduction-side vertical channel and the width of the drainage-side vertical channel.

5. The cell frame according to claim 1, wherein a depth of the horizontal channel is smaller than a depth of the introduction-side vertical channel and the drainage-side vertical channel.

6. The cell frame according to claim 1, wherein a plurality of diffusion channel units are arranged in the width direction of the cell frame; and
adjacent ones of the diffusion channel units share the introduction-side vertical channel or the drainage-side vertical channel.

7. The cell frame according to claim 1, wherein the introduction-side flow guiding channel, the drainage-side flow guiding channel, and the diffusion channel unit are provided in the bipolar plate.

8. The cell frame according to claim 1, wherein the introduction-side flow guiding channel and the drainage-side flow guiding channel are provided in the frame body, and the diffusion channel unit is provided in the bipolar plate.

9. A cell stack comprising the cell frame according to claim 1.

10. A redox flow battery comprising the cell stack according to claim 9.
